(19) United States
(12) Patent Application Publication
(10) Pub. No.: US 2026/0252595 A1
(43) Pub. Date: Aug. 27, 2026

(54) ALTERNATE QUERY GENERATION ENGINE

(71) Applicant: eBay Inc., San Jose, CA (US)

(72) Inventors: Mehran ELYASI, San Francisco, CA (US); Ishita Kamal KHAN, San Jose, CA (US); Rui KONG, Portland, OR (US); Aritra MANDAL, San Jose, CA (US); Gabriela MONTIEL MORENO, San Jose, CA (US); Harish VEMPATI, San Jose, CA (US); Shuang ZHOU, San Jose, CA (US)

(21) Appl. No.: 19/374,878

(22) Filed: Oct. 30, 2025

Related U.S. Application Data
(60) Provisional application No. 63/761,805, filed on Feb. 21, 2025.

(51) Int. Cl. G06F 16/3329; G06F 40/30; G06N 20/00

(52) U.S. Cl. CPC G06F 16/3329; G06F 40/30; G06N 20/00

(57) ABSTRACT

Methods, systems, and computer storage media for providing a query management engine and alternative query generation engine in an item listing system are described. A query management engine is designed to improve search relevance by leveraging the alternate query generation engine. In operation, user behavior data comprising a search session associated with a query sequence is accessed. A source query, a transitional query, and a target query of the query sequence associated with the search session are segmented. The query sequence is selected using intent filtering, wherein the selection is based on a determination that the intent of the source query is maintained from the source query through the transitional query to the target query. A Large Language Model (LLM) alternate query generator is trained on the query sequence to generate alternate target queries; each alternate target query corresponds to the intent of the target query in the query sequence.

### CROSS-REFERENCE TO RELATED APPLICATIONS

This application claims the benefit of U.S. Provisional Application No. 63/761,805, filed on February 21, 2025. The entire contents of which are incorporated herein by reference.

### BACKGROUND

Users leverage AI to automate tasks, enhance decision-making, and optimize processes by analyzing large amounts of data and providing insights or predictions. Artificial Intelligence (AI) has become a cornerstone across multiple industries, driving innovation in various domains. AI has become a pivotal technology in modern platforms, particularly in enabling systems to process large volumes of data quickly and accurately. By leveraging advanced computational models and algorithms that replicate cognitive processes, AI can automate query handling, optimize decision-making, and improve system responsiveness. For example, AI is particularly valuable in the context of an item listing system to facilitate managing and executing queries related to product searches, user preferences, inventory data, and pricing information.

### SUMMARY

Various aspects of the technology described herein are generally directed to systems, methods, and computer storage media for, among other things, providing a query management engine that is designed to optimize search relevance and improve the user experience by leveraging an alternate query generation engine. The alternate query generation engine is designed to enhance search experiences by dynamically generating alternative search queries based on user behavior and intent. The alternate query generation engine begins by analyzing user query sequences, segmenting them into source, transitional, and converging queries, ensuring a comprehensive understanding of the user’s evolving intent. The alternate query generation engine uses an intent filtering mechanism to identify and exclude irrelevant queries that deviate from the source query's intent, ensuring only relevant query transitions are considered. A Large Language Model (LLM) is then applied to generate alternative converging queries, offering diverse and relevant options that align with the user’s search journey – effectively fast-forwarding users to their intended results by presenting new search options. These alternative queries are integrated into the search results page (SRP) as interactive carousels, guiding users through a personalized and efficient search process that increases engagement and conversion potential.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIGS. 1A – 1G are block diagrams of an artificial intelligence system for providing alternate query generation management, in accordance with aspects of the technology described herein;

FIG. 2A is a block diagram of an artificial intelligence system for providing alternate query generation management, in accordance with aspects of the technology described herein;

FIG. 2B is a block diagram of an artificial intelligence system for providing alternate query generation management, in accordance with aspects of the technology described herein;

FIG. 3 provides a first exemplary method of providing query management using an alternate query generation engine in an artificial intelligence system, in accordance with aspects of the technology described herein;

FIG. 4 provides a second exemplary method of providing query management using an alternate query generation engine in artificial intelligence system, in accordance with aspects of the technology described herein;

FIG. 5 provides a third exemplary method of providing query management using an alternate query generation engine in artificial intelligence system, in accordance with aspects of the technology described herein;

FIG. 6 provides a block diagram of an exemplary artificial intelligence system computing environment suitable for use in implementing aspects of the technology described herein;

FIG. 7 provides a block diagram of an exemplary distributed computing environment suitable for use in implementing aspects of the technology described herein; and

FIG. 8 is a block diagram of an exemplary computing environment suitable for use in implementing aspects of the technology described herein.

### DETAILED DESCRIPTION

### Overview

An item listing system and platform support storing items (products or assets) in item databases and providing a search system for receiving queries and identifying search result items based on the queries. An item (e.g., physical item or digital item) refers to a product or asset that is provided for listing on an item listing platform. Search systems support identifying, for received queries, result items from item databases. Item databases can specifically be for content platform or item listing platforms such as EBAY content platform, developed by EBAY INC., of San Jose, California.

Item listing systems employ query management for optimizing how users interact with and find relevant listings within these platforms. Query management functionality involves the systems and processes designed to optimize the execution and relevance of user search queries across various platforms. It typically includes the stages of query processing, query refinement, ranking, and result retrieval. This process aims to deliver the most relevant and timely information by leveraging data about user behavior, search patterns, and historical queries. Traditional query management systems utilize keyword matching, ranking algorithms, and basic relevance scoring to present search results. More advanced systems integrate user feedback, personalization, and context to fine-tune results dynamically. Effective query management plays a crucial role in enhancing user experience by making searches faster, more relevant, and tailored to individual needs.

An item listing system may also provide generative-AI-supported applications (“generative AI applications”) that leverage generative AI models (e.g., Large Language Models – “LLM”) to create, generate, or produce content, data or outputs. LLMs are a specific class of generative AI models that are primarily focused on generating human-like text. Generative AI models, like GPT (Generative-Pre-trained Transformer) and its variants, are designed to generate human-like text or other types of data based on the input they receive (e.g., via a prompt interface). These applications use generative AI to perform various task across different domains to provide improvement in automation, efficiency, and human-like interaction. Item listing systems are beginning to integrate AI to streamline search and improve user interactions by analyzing vast amounts of user and product data. AI enhances these systems by enabling smarter categorization, better personalization, and more accurate recommendations, ultimately improving the efficiency and relevance of product searches.

Conventional search systems primarily rely on single-query inputs without dynamically adapting to user behavior or providing personalized, alternative search pathways, often leading to suboptimal search experiences and higher abandonment rates. During search sessions, users typically refine their queries through multiple iterations before finding a product that meets their specific criteria, including relevance, price, and availability. These intermediate or transitional queries, situated within the middle of the session funnel, often result in suboptimal search experiences. For instance, a user might initially search for "wireless headphones," then refine the query to "affordable noise-cancelling wireless headphones" as they narrow their options. This process can lead to non-converting searches if the user doesn't find an adequate match, impacting key performance metrics. Such transitional queries contribute to several negative outcomes, such as high session abandonment rates, extended time to conversion, low click-through rates (CTR) on search results, and an increased rate of null-result searches (where no relevant products are found). As such, a more comprehensive query management engine – with an alternative basis for providing query management functionality– can improve computing operations and interfaces for search systems including item listing systems.

### Description of Technical Solution

At a high level, a query management engine is provided to optimize search relevance and improve the user experience by leveraging an alternate query generation engine. The alternate query generation engine includes multiple components working in sequence to enhance a search experience – for instance, a search experience on an item listing system. The process begins with user search sessions being continuously logged and analyzed to track query evolution. These sessions are stored in a structured behavioral database that captures key events such as query submissions, product views, and transactional actions like purchases, bids, and items added to the cart. The alternate query generation engine extracts meaningful sequences from these sessions, identifying the source query, transitional queries, and eventual target queries that lead to conversions.

A sequence generation and transition finder engine is responsible for analyzing search behavior to detect transitional query chains. The alternate query generation engine first crawls search logs and identifies query sequences where at least one transactional event (buy, bid, offer, watch, ask, cart click) occurs. Sequences are segmented into meaningful search journeys, ensuring that only user sessions containing multiple search interactions are considered. The sequence generation and transition finder engine splits session sequences at key transactional events to maintain coherence in query evolution.

Following sequence generation, an intent filtering mechanism is applied to refine the extracted search sequences. The intent filtering mechanism determines whether a set of queries share a common intent by using a similarity model trained on query embeddings. The process involves traversing the query sequence in reverse order, starting from the final converging query, and evaluating the similarity between each preceding query and its successor. If the similarity score falls below a predefined threshold, the query is deemed to be outside the intent boundary and is excluded from further analysis. This ensures that the generated alternative queries remain relevant to the user's original search intent and do not introduce noise.

Once the filtered transitional queries are obtained, the alternate query generation engine employs a large language model (LLM) alternator to generate alternative query suggestions. The LLM alternator can be a fine-tuned using instruction-based learning on an open-source model that is provided with structured input data that includes the source query, a list of transitional queries, and the corresponding converging queries mined from historical search sessions. The LLM alternator is guided through a custom prompt that instructs it to produce a list of alternative converging queries that differ from those initially found in the user sequence while maintaining contextual relevance. The generated queries leverage external world knowledge to enhance search results, incorporating brand recognition and product attributes that align with user expectations.

The output of the LLM alternator is passed to the alternate search experience engine, which integrates the newly generated alternative queries into the search results page. When a user submits a search query, the search front-end interface sends the request to search services, which in turn communicates with the search sciences backend to retrieve relevant search results. The alternate search experience engine enhances this process by intercepting transitional queries and appending AI-generated alternate queries to the results. These alternate queries are presented in a structured query carousel, providing users with refined search options that increase the likelihood of conversion.

To ensure real-time performance, the alternate query generation engine leverages a combination of batch processing and low-latency inference. The mining of user search behavior and sequence generation occurs in offline batch jobs that periodically update the model’s understanding of query transitions. The LLM alternator, however, operates in real-time using a lightweight inference pipeline optimized for latency. When a user encounters a transitional query, the system fetches precomputed alternative queries or generates new ones on demand based on the latest search trends.

Data governance and evaluation mechanisms are built into the system to monitor its effectiveness. The success of the generated alternate queries is measured using key performance indicators such as click-through rate, conversion rate, and session abandonment rate. A/B testing is conducted to compare search experiences with and without AI-generated queries, ensuring continuous refinement of the model. Additionally, feedback loops are integrated into the system to retrain the LLM alternator based on user interactions, allowing the model to adapt to evolving search behaviors.

The end-to-end architecture is designed to be modular and scalable, allowing for the continuous improvement of search query generation. By leveraging a combination of behavioral data mining, embedding-based similarity models, and fine-tuned language models, the system effectively enhances the search journey, reducing user friction and improving overall shopping experience.

By way of example, a user can use an LLM alternator to generate alternative queries based on real user search data. The example begins with a user search journey, which includes a source query, a transitional query, and a converging query. These queries are extracted from a user behavioral database of an item listing system, reflecting actual search patterns.

The user’s source query includes searches for “18k gold Brand Name 1” and “Brand Name 1 chain gold 18k”. These queries indicate an initial interest in gold jewelry from the Brand Name 1. As the user refines their search, they enter a transitional query, which is recorded as “18k gold diamonds necklace”. This transitional query represents a middle stage in the search journey, where the user is exploring related products but has not yet reached a definitive purchase decision.

The LLM Alternator processes this query sequence to generate alternative converging queries. When the LLM receives the input query sequence, it is instructed to generate a set of new, contextually relevant search terms that differ from the originally observed converging queries. The goal is to suggest alternative queries that maintain the same underlying intent while expanding the search scope to more relevant or popular options.

After processing the input, the LLM produces the following alternative queries:

"18k white gold diamond necklace"

"18k yellow gold diamond necklace"

"18k gold diamond pendant necklace"

"18k gold diamond necklace Brand Name 1"

"18k gold diamond necklace Brand Name 2"

"18k gold diamond necklace Brand Name 3"

"18k gold diamond necklace Brand Name 4"

From this output, several key observations are made. First, the LLM correctly follows the instructions by providing a set of alternate converging queries instead of simply repeating the user-generated converging queries. Second, the model successfully recognizes the brand context from the original queries, incorporating well-known luxury jewelry brands such as Brand Name 2, Brand Name 3, and Brand Name 4. This demonstrates that the LLM is capable of leveraging world knowledge to improve search relevance. Third, the alternative queries align with the user’s intent by maintaining a focus on 18k gold and diamond necklaces, ensuring that the generated suggestions remain useful and relevant.

This example illustrates how the alternate query generation engine can intelligently expand search options when users enter transitional queries that may otherwise lead to non-converting or frustrating search experiences. By integrating this approach into an item listing system’s Search Results Page (SRP), users encountering low or null-result searches will be presented with an enriched set of query alternatives, helping them discover products more efficiently and improving overall search satisfaction.

### Example System and Resources

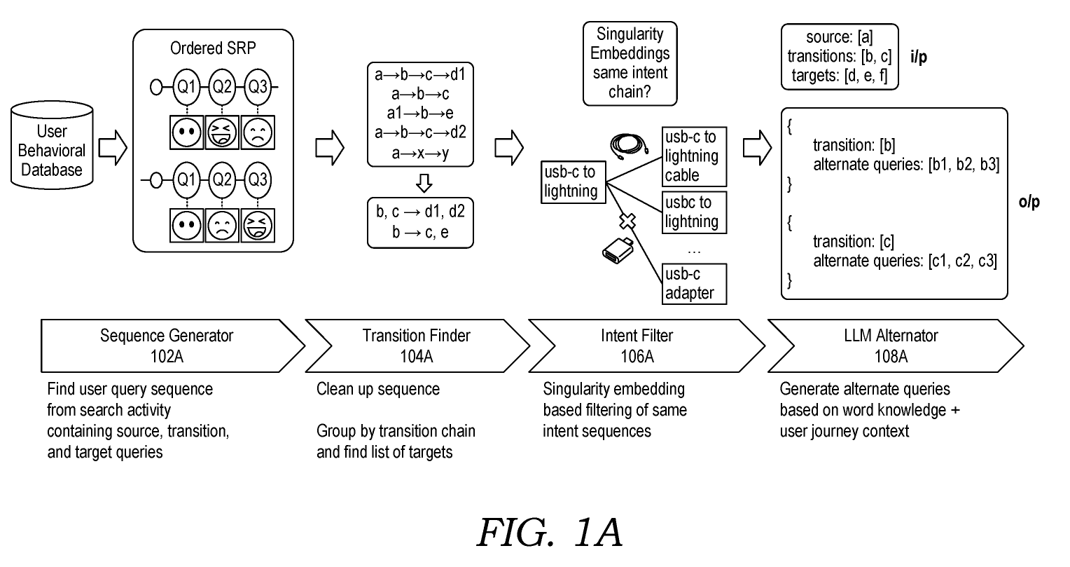

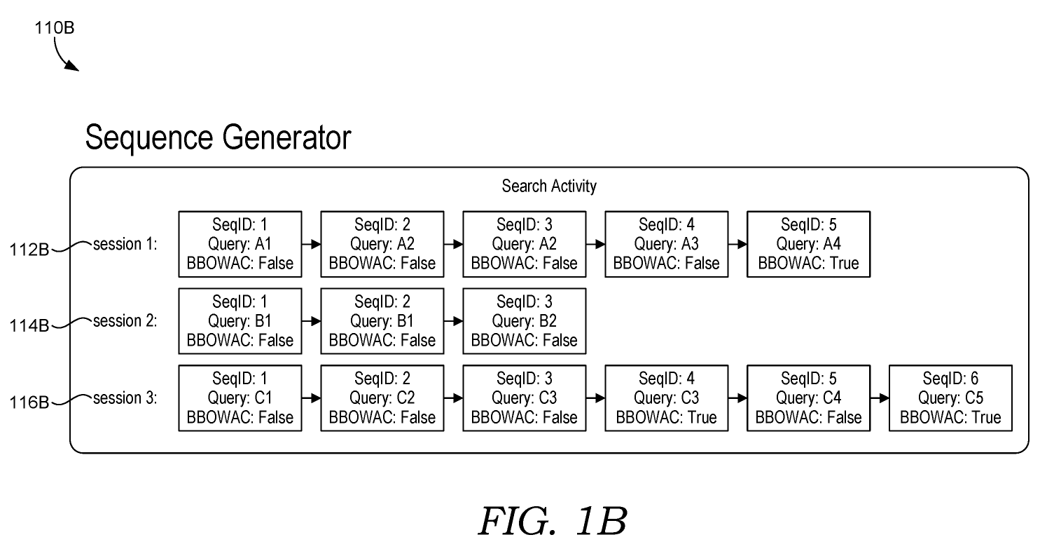

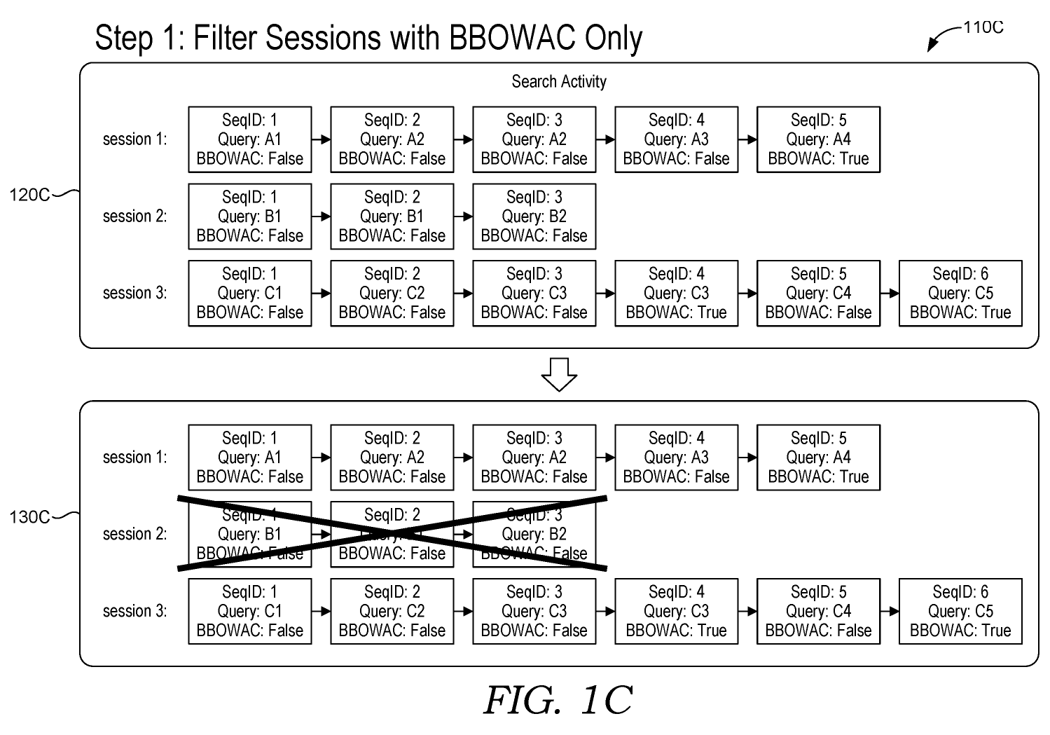

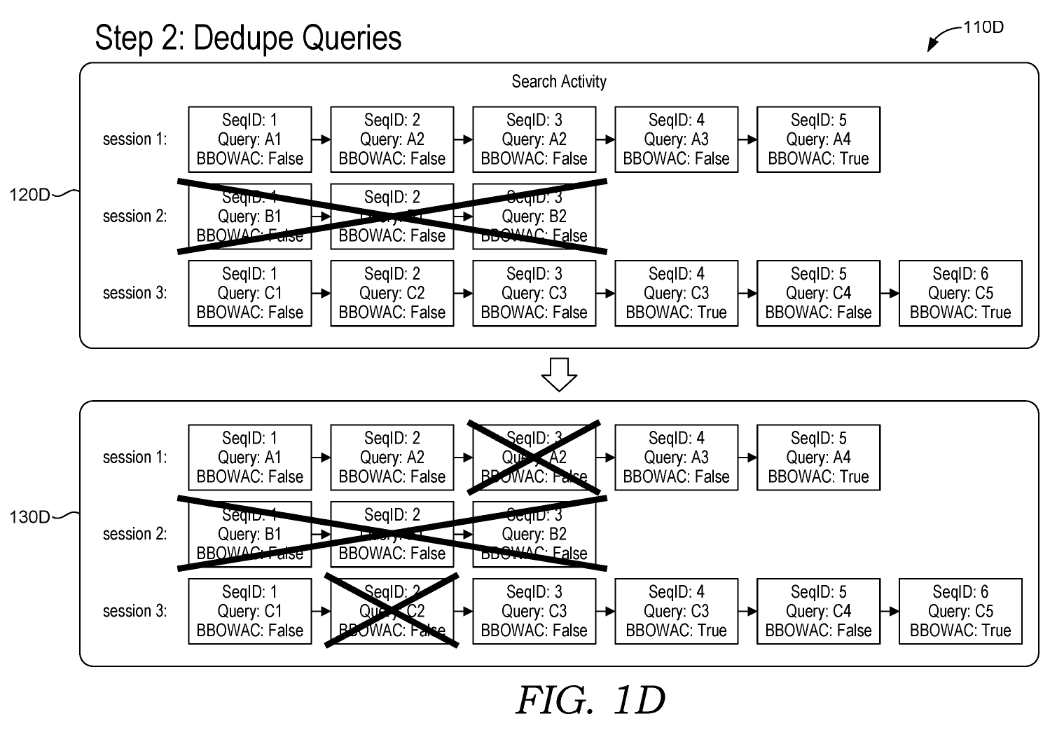

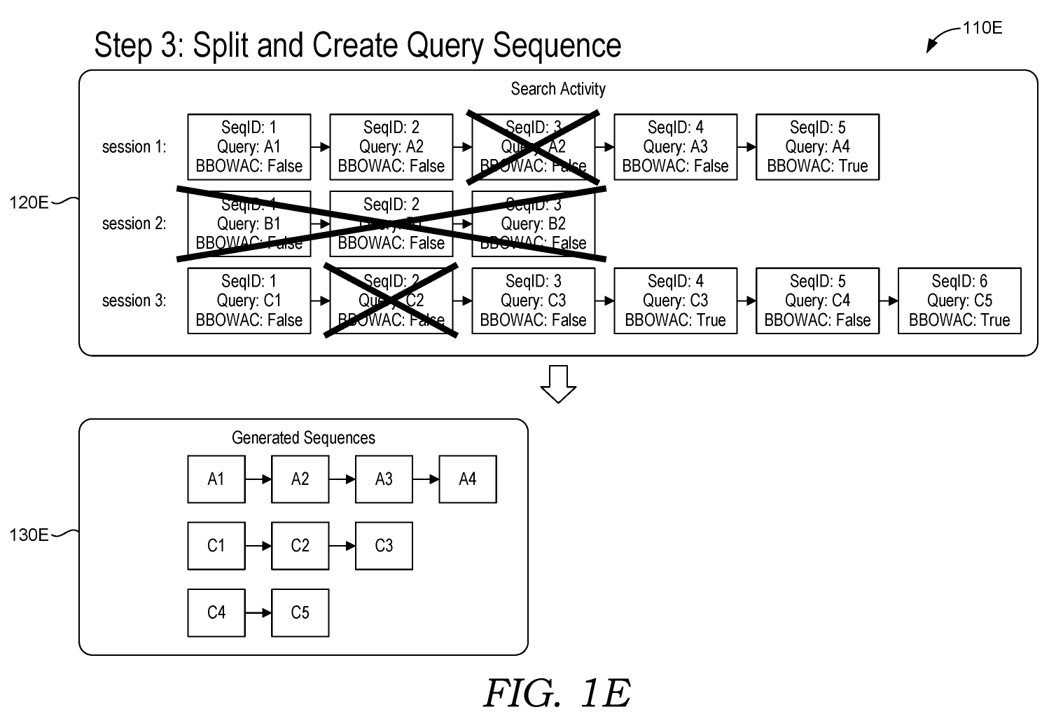

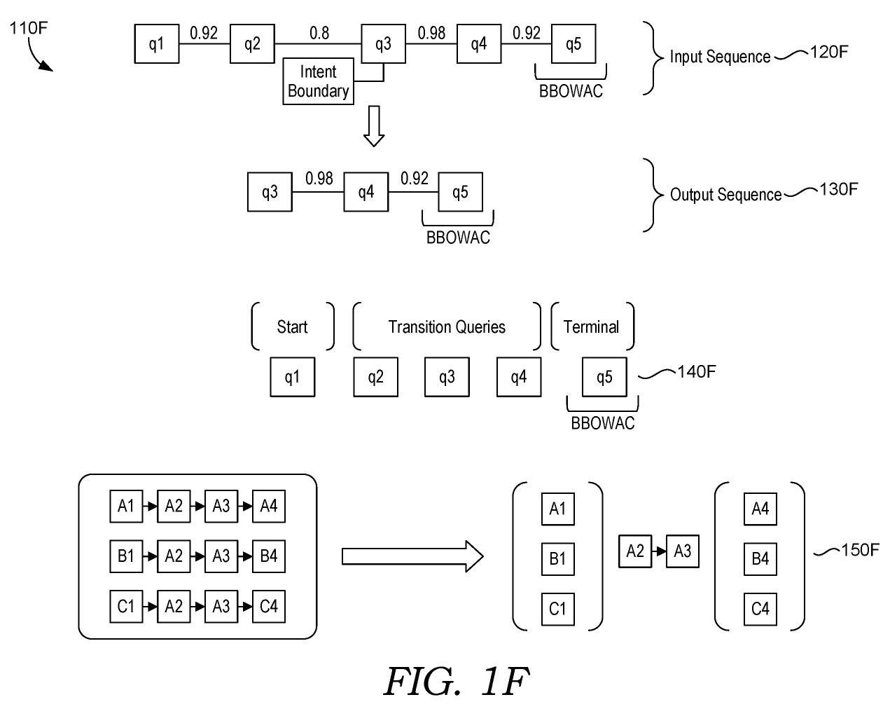

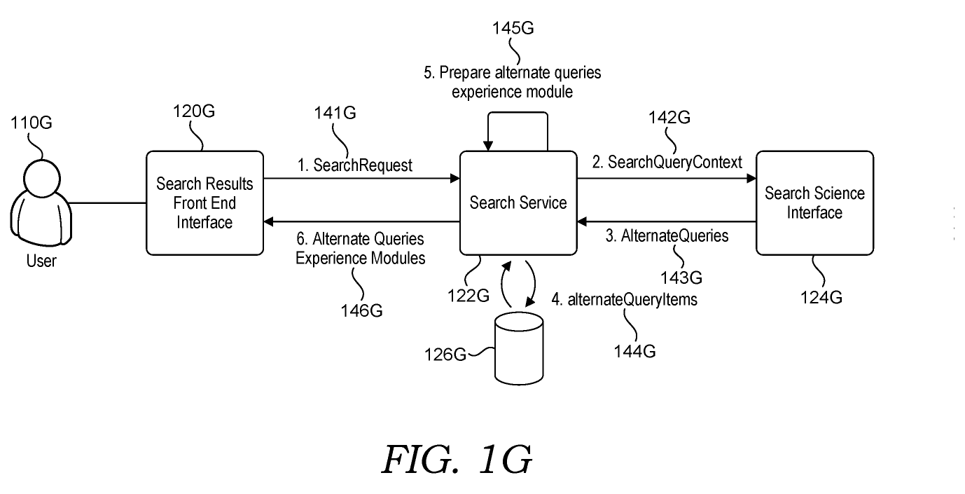

Aspects of the technical solution can be described by way of examples and with reference to FIGS. 1A – 1G.

FIG. 1A illustrates the end-to-end architecture of the alternate query generation engine as an AI-guided alternate query generation system, showing how user behavior is transformed into high-quality alternate queries for enhancing the search experience. FIG. 1A is structured as a pipeline of four main components—each labeled with a corresponding reference numeral (102A, 104A, 106A, 108A)—and reflects the logical and data flow of the technical solution.

At step 120A: sequence generator ingests raw data from the user behavioral database, which logs search activities across item listing platform sessions. It identifies and segments query sequences that contain at least one source query, one or more transitional queries, and at least one target query associated with a transactional event (e.g., buy, bid, watch). This step surfaces the foundational data structure needed for training and inference: an ordered sequence of user queries that reflects intent evolution during product discovery.

At step 104A: transition finder processes the sequences extracted by the sequence generator. It cleans up the data by removing noise and partial chains, then groups queries by transition chains and associates them with corresponding target queries (e.g., b, c → d1, d2). This step allows the system to explicitly map which transitional queries historically led to meaningful outcomes, forming labeled input-output pairs for training.

At step 106A: intent filter applies a singularity embedding-based similarity model to the grouped query sequences. Its goal is to ensure that each query in the chain shares a consistent user intent, removing outliers that might derail the training or result in irrelevant suggestions. This filtering is based on semantic similarity scores, computed via embeddings, and excludes any sequence where a shift in intent is detected (e.g., "USB-C to lightning cable" vs. "USB-C to adapter").

At step 108A: LLM alternator accesses the cleaned, intent-aligned query sequences and uses a fine-tuned large language model to generate alternate target queries for each transitional query. The input to the LLM includes:

The source query

The transitional queries

The associated target queries

Using this context, the LLM outputs brand-aware, world-knowledge-enriched alternate queries that are structurally distinct but semantically relevant (e.g., b → [b1, b2, b3]). These alternate queries are then surfaced to users in the search interface, often in the form of query carousels, helping them refine their search with minimal effort.

With reference to FIG. 1B, FIG. 1B illustrates the internal logic of the sequence generator 110B. FIG. 1B visually represents how raw search activity data from multiple user sessions is processed to form structured query sequences that will be passed downstream for intent filtering and alternate query generation. FIG. 1B depicts three search sessions (session 1 112B, session 2 114B, session 3 116B), each consisting of a series of queries issued by a user. For every query, the system may record the following metadata:

A SeqID (sequence index for ordering),

The Query itself (e.g., A1, B1, C3),

A BBOWAC flag indicating whether the query led to a transactional event (Buy, Bid, Offer, Watch, Ask, Cart, or Click).

Session 1 contains four sequential queries (A1 to A4), with the final query A4 (SeqID 5) marked BBOWAC: True. → This is a valid query sequence, with A1–A3 considered source and transitional queries, and A4 serving as the target query that led to a transactional event. The full sequence is retained for downstream modeling.

Session 2 includes three queries (B1, B2, B3), all marked BBOWAC: False. → Since no transactional event occurred, this session does not qualify as a valid converging sequence. It may be discarded or truncated depending on implementation rules, as it lacks the engagement signal needed to define a target query.

Session 3 includes six queries, with BBOWAC events at C3 (SeqID 3) and C5 (SeqID 6). → The system splits this session into two valid sub-sequences: One from C1 → C2 → C3, ending with a transactional query. Another from C4 → C5, also ending with a transactional query.

As shown in FIG. 1B, the sequence generator supports transforming raw user behavior data into structured query sequences. The sequence generator begins by extracting search activity logs from individual user sessions and organizing the queries in sequence using unique identifiers known as SeqIDs, which preserve the temporal order of each action. The sequence generator then scans for BBOWAC events—signals such as buy, bid, offer, watch, ask, cart, or click—that indicate meaningful user engagement. These events serve as markers for the endpoint of a valid query sequence. When one or more BBOWAC events are detected, the sequence generator forms one or more sub-sequences by identifying the corresponding source and transitional queries that precede the transactional event. In sessions where multiple BBOWAC events occur, such as in Session 3 116B, the sequence generator intelligently splits the session into separate converging chains, each with its own valid target query. This ensures that only intent-aligned, engagement-driven query paths are passed forward for intent filtering and alternate query generation. In this way, the sequence generator provides data preprocessing logic that supports the downstream components—such as the transition finder, intent filter, and LLM alternator.

FIG. 1C – 1E provides a step-by-step visual overview of the sequence generator’s preprocessing pipeline, which is responsible for transforming raw user search activity into high-quality, conversion-anchored query sequences. The sequence generator supports identifying structured user journeys that end in meaningful actions—such as clicks, purchases, or cart additions—referred to as BBOWAC events (Buy, Bid, Offer, Watch, Ask, Cart).

The sequence generator supports three sequential stages: (1) filtering sessions to retain only those with transactional signals, (2) deduplicating repeated queries to improve sequence quality, and (3) segmenting sessions with multiple BBOWAC points into independent converging chains. Each resulting sequence captures a clear narrative of user intent evolution—from the initial source query through transitional refinements to a final target query that results in engagement.

This preprocessing ensures that only valid, intent-aligned, and semantically clean query chains are passed into downstream components such as the transition finder, intent filter, and LLM alternator, enabling more accurate generation of alternate queries and improved user experience.

In FIG. 1C Step 1 – filter sessions with BBOWAC only 110C shows the initial step in the sequence cleaning process, where only sessions containing at least one BBOWAC event (Buy, Bid, Offer, Watch, Ask, Cart, Click) are retained. The search activity 120C shows three full search sessions, with BBOWAC flags indicated for each query. Session 1 contains five queries (A1 to A4), with A4 marked as BBOWAC: True. Session 2 has three queries (B1 to B3), none marked with BBOWAC: True. Session 3 contains six queries (C1 to C5), with C3 and C5 marked BBOWAC: True.

Search activity 130C shows the result of filtering: Session 1 and Session 3 are retained since they contain transactional events. Session 2 is discarded entirely, as it lacks any BBOWAC events.

In FIG. 1D Step 2 – dedupe queries 110D identifies and removes duplicate queries within sessions (i.e., avoiding duplication of original converging queries). The search activity 120D displays the previously retained sessions (1 and 3). In Session 1, duplicate queries such as A2 appearing twice (SeqIDs 2 and 3) are marked for removal. In Session 2 (already removed), no further action is needed. In Session 3, the query C3 appears twice (SeqIDs 3 and 4) and is deduplicated.

The search activity 130D shows the updated sequences: Session 1 now consists of A1, A2, A3, A4 (unique entries only). Session 3 includes C1, C2, C3, C4, C5, with only unique query instances retained. This step eliminates redundancy and ensures sequence quality.

In FIG. 1E Step 3 – split and create query sequence 110E shows how the cleaned sessions are split into independent converging sub-sequences, each ending in a BBOWAC: True query. For search activity 120E Session 1 yields one valid sequence: A1 → A2 → A3 → A4. Session 3 contains two BBOWAC events (C3 and C5), and is therefore split into two separate sequences: First sequence: C1 → C2 → C3; Second sequence: C4 → C5

As shown in generated sequences 130E, three generated sequences include: one from Session 1 (A-series) and two from Session 3 (C-series, split at multiple BBOWAC points) These sequences are now clean, non-duplicated, BBOWAC-anchored chains that are ready to be passed into the intent filter and LLM alternator stages for training or inference.

FIG. 1F illustrates the internal logic and processing stages involved in refining query sequences within the behavioral insight pipeline, particularly focusing on identifying and extracting intent-aligned subsequences. FIG. 1F demonstrates how the system uses intent boundaries, transition scoring, and BBOWAC indicators to isolate the most meaningful segments from user search activity.

Processing pipeline 110F shown in the figure in FIG. 1F provides the input query sequence 120F through sequence truncation and role classification 140F to the final normalized outputs 150F. Processing pipeline 110F only supports extracting intent-aligned sub-sequences for downstream processing.

The input sequence 120F contains five queries (q1 to q5) with associated confidence scores between transitions. A low transition probability between q2 and q3 flags an intent boundary, prompting the system to truncate the earlier portion and retain the converging sequence (q3 → q4 → q5) as the output sequence 130F. This ensures only intent-cohesive paths are passed forward.

The sequence truncation and role classification 140F is associated with a logical schema that classifies each query’s role in the sequence—Start, Transition, or Terminal (BBOWAC)—enhancing downstream interpretability and structural consistency.

Final normalized outputs 150F are associated to with a sequence normalizer that shows how multiple raw query chains are parsed and normalized into compact, aligned sub-sequences. This segmentation phase reduces noise, supports batch processing, and enables uniform formatting of data for subsequent stages like the transition finder and LLM alternator.

By way of example, a user begins a search session on an item listing platform looking for a smartwatch and enters the first query, “apple watch series 3” (q1). They then refine it slightly to “apple watch series 3 GPS” (q2), which still aligns with the original intent. However, the next query, “fitbit charge 5” (q3), marks a shift in product category and brand. The system computes semantic similarity scores between consecutive queries and identifies a sharp drop between q2 and q3, flagging an intent boundary. As a result, the initial portion of the sequence—q1 and q2—is pruned, and only the sub-sequence from q3 onward is retained for further analysis. The user continues by searching “fitbit charge 5 black band” (q4) and finally clicks on a product after typing “fitbit charge 5 new sealed” (q5), which is logged as a BBOWAC event.

The system then parses this retained sequence—q3, q4, q5—and assigns structural roles: q3 and q4 are identified as transitional queries, while q5 is the target query that concludes in a transactional action. Meanwhile, in parallel, another session includes queries like “Samsung galaxy watch 4” → “galaxy watch 4 classic LTE” → “best buy galaxy watch 4,” with no engagement recorded, and is thus discarded entirely.

Through this process, the sequence normalizer produces structured, intent-aligned outputs such as: “fitbit charge 5” → “fitbit charge 5 black band” → “fitbit charge 5 new sealed” These normalized sequences are now suitable for training the LLM Alternator or for generating alternate queries to guide future users toward successful outcomes. This example shows how FIG. 1F's logic—intent boundary detection, role classification, and BBOWAC anchoring—ensures that only meaningful user journeys are retained and prepared for intelligent query rewriting.

With reference to FIG. 1G, FIG. 1G illustrates the operational flow of the alternate query generation engine, showing how alternate queries are dynamically generated and surfaced in response to a user’s search input, as part of the broader technical solution.

FIG. 1G illustrates the end-to-end flow of the alternate query generation engine, depicting how user-initiated search activity results in the generation and surfacing of alternate queries. The figure highlights key components and their roles in the pipeline:

User 110G: The end user who submits a search query through the search interface.

Search results front end interface 120G: The UI layer where search results and alternate queries are presented to the user.

Search service 122G: The core orchestration engine that handles incoming search requests, communicates with science models, and prepares the alternate query experience.

Search science interface 124G: A backend component that applies ML models and logic to generate AlternateQueries 143G from the SearchQueryContext 142G.

Search index or query item store 126G: A storage system that contains items or listings used to contextualize and enrich alternate queries.

Search request 141G: The original user query and session data passed from the front end to the Search Service.

AlternateQueries 143G: Semantically or behaviorally related queries generated to improve discovery and relevance.

alternateQueryItems 144G: Content-rich representations of alternate queries, retrieved from the index for front-end presentation.

Alternate queries experience module 145G: A processing module that formats and packages alternate queries for display.

Experience delivery 146G: The final delivery of curated alternate query results to the user-facing interface.

The process begins with a user 110G issuing a search via the search results front end interface 120G. This request 141G is routed to the search service 122G, which orchestrates the alternate query generation pipeline. Upon receiving the query, the search service generates a SearchQueryContext 142G and forwards it to the search science interface 124G. This context may include the user’s original query, session metadata, and BBOWAC-tagged sequence elements.

The search science interface 124G, in turn, leverages trained models (not shown here) to generate a list of AlternateQueries 143G tailored to the user’s original search intent. These alternatives are returned to the search service 122G, which maps them to associated content or listings stored in the search index or query item store 126G. This step produces alternateQueryItems (144G), which enrich the raw alternate queries with concrete, displayable results.

The search service 122G then prepares 145G alternate queries experience modules that support assembling alternate queries into a format consumable by the front-end system. Finally, the alternate queries experience modules returned through experience delivery 146G to the search results front end interface 120G, enabling users to interact with the alternate queries alongside their original search results.

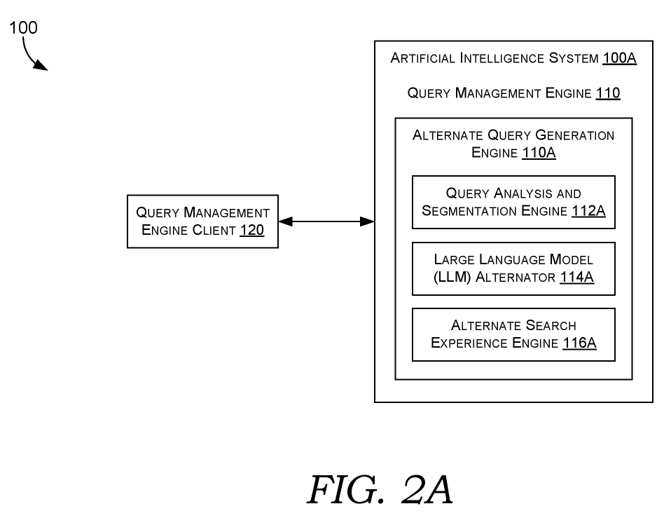

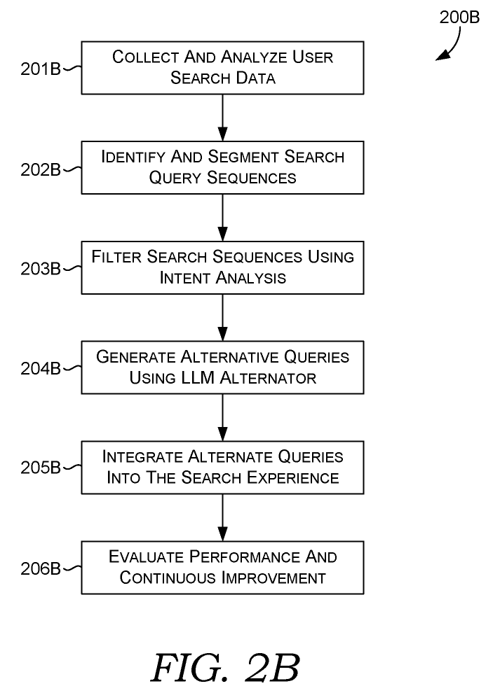

With reference to FIG. 2A, FIG. 2A illustrates cloud computing system 100 (e.g., of an item listing system) including artificial intelligence (AI) system 100A, query management engine 110, alternate query generation engine 110A including query analysis and segmentation engine 112A, Large Language Model (LLM) alternator 114A, alternate search experience engine 116A; and query management engine client 120.

The query analysis and segmentation engine 112A is responsible for identifying, extracting, and structuring user search behavior into meaningful query sequences. Query analysis and segmentation engine 112A continuously analyzes search logs and tracks how users refine their queries over time. Query analysis and segmentation engine 112A segments user search sessions into three key categories: source queries, transitional queries, and converging queries. By recognizing the evolution of a search journey, the alternate query generation engine 110A can determine where users struggle to refine their searches effectively. Additionally, an intent filtering mechanism ensures that only queries sharing a common underlying intent are considered for alternate query generation, preventing irrelevant or overly broad suggestions. This foundational component ensures that the alternate query generation engine 110A works with high-quality query data, setting the stage for meaningful AI-driven enhancements.

The LLM alternator 114A generates contextually relevant alternative queries. LLM alternator 114A can be fine-tuned on an item listing platform’s historical search behavior to predict what users are most likely searching for, even when their queries are ambiguous or suboptimal. When a transitional query is identified, the LLM alternator 114A receives input including the source query, transitional query history, and previous converging queries. LLM alternator 114A then generates optimized alternate queries that differ from the original converging queries while remaining highly relevant. This process leverages world knowledge and brand recognition, allowing the model to incorporate well-known product categories, brand names, and industry-specific terms to refine results. By intelligently expanding and restructuring search queries, the LLM alternator 114A reduces search friction and increases the likelihood of conversion by guiding users toward more effective search refinements.

Alternate search experience engine 116A integrates the AI-generated alternate queries into the search results page (SRP), providing a seamless and interactive user experience. When a user submits a search query, for example, via a query management engine client, the alternate search experience engine dynamically retrieves relevant product listings while simultaneously fetching precomputed or real-time AI-generated alternate queries. These alternatives are displayed, using the query management engine client 120, as a query carousel or a suggested search refinement section on the SRP, allowing users to explore additional search options effortlessly.

The alternate search experience engine 116A is also responsible for query ranking and real-time search result adjustments, ensuring that the most relevant and high-converting alternate queries are prioritized. Alternate search experience engine 116A interacts with the caching and personalization systems to tailor search refinements based on user behavior, location, and past interactions. Additionally, this engine integrates A/B testing and performance tracking, measuring the impact of alternate queries on engagement, click-through rates (CTR), and conversion rates. By seamlessly embedding AI-enhanced search guidance within the user experience, this alternate search experience engine 116A plays a role in driving more effective product discovery and improving overall search satisfaction.

For clarity and efficient reference, a glossary of key terms and concepts pertinent to the technical solution associated with an alternate query generation engine is provided below.

BBOWAC – BBOWAC: stands for Buy, Bid, Offer, Watch, Ask, Cart Click — a set of key user engagement actions in an e-commerce or marketplace platform. These actions represent various stages of buyer interest and intent. Buy indicates immediate purchase; Bid involves competing in an auction; Offer allows proposing a price; Watch tracks items without commitment; Ask refers to the seller’s price; and Cart Click signals intent to purchase by adding the item to a cart. Tracking BBOWAC metrics helps sellers and platforms understand buyer behavior, optimize listings, and forecast demand based on how users interact with specific items.

Transitional Queries – These are intermediate search queries that users enter as they refine their search for a product. The alternate query generation engine identifies these queries to improve their relevance by suggesting AI-generated alternatives, ensuring that users move efficiently toward a successful purchase.

Search Results Page (SRP) – The page displayed to users after they submit a query, containing product listings and related information. The system enhances the SRP by integrating query carousels with AI-generated alternate queries, allowing users to refine their searches dynamically.

Intent Filtering – A process that determines whether queries within a sequence share a common underlying intent. Using a query similarity model, the system evaluates whether each query logically follows the previous one, ensuring that only related search refinements are used for alternate query generation.

LLM Alternator – A fine-tuned large language model (LLM) that generates alternative search queries based on user behavior and world knowledge. It ensures that alternate queries remain relevant, diverse, and brand-aware, helping users refine their search with better query suggestions.

Embedding-Based ML Model – A machine learning model that represents search queries as numerical vector embeddings. This model allows the system to analyze search patterns, detect query similarities, and predict optimized refinements for improved search results.

Query Carousels – A user interface feature that presents AI-generated alternate queries in a horizontally scrollable format on the SRP. This allows users to explore refined search options easily without manually entering new queries.

Sequence Generator and Transition Finder – An engine that extracts, segments, and organizes search query sequences from user behavior. It identifies the source query, transitional queries, and converging queries, ensuring that only meaningful search refinements are processed.

Alternate Search Experience Engine – The backend system that integrates alternate queries into the search experience. This engine processes user queries, retrieves AI-enhanced alternatives, and dynamically adjusts search results to improve relevance and engagement.

Query Similarity Model – A machine learning algorithm that evaluates the semantic relationship between queries. It determines whether a query should be included in a search refinement sequence based on its similarity to previous queries, helping the system maintain search intent continuity.

Search Services Interface – The API-driven component that manages communication between the front-end search UI, the search sciences backend, and the alternate query generation system. It ensures that queries are processed efficiently and that AI-generated suggestions are seamlessly integrated into the search workflow.

With reference to FIG. 2B, FIG. 2B, illustrates a schematic 200B associated with providing a query management in accordance with embodiments described herein. The implementation of the alternate query generation engine follows a structured step-by-step process designed to improve search efficiency and user experience. Each step contributes to identifying, refining, and enhancing user queries through data mining, machine learning models, and real-time search result enhancements. The technical solution of the alternate query generation engine can be explained by way of steps and an example alternate query generation implementation.

Step 201B: Collecting and Analyzing User Search Data –The alternate query generation engine continuously monitors and records search activities within an item listing system. User queries submitted during a session, along with interactions such as clicks, purchases, or items added to a watchlist or cart, is logged in a behavioral database. This data provides a structured sequence of queries for each shopping session, enabling the alternate query generation engine to trace how users refine their searches over time. The alternate query generation engine also captures buy, bid, offer, watch, ask, cart click (bbowac) events, which indicate significant shopping intent. Query sequences that contain at least one of these events are flagged for further processing.

Step 202B: Identifying and Segmenting Search Query Sequences – Once the search data is collected, the system employs a sequence generation and transition finder engine to identify meaningful query chains. Each session is broken down into three key components:

Source query: The initial search entered by the user.

Transitional queries: Intermediate search refinements that occur as the user navigates the search experience.

Converging queries: The final queries leading to a purchase or other transactional action.

This segmentation is performed to understand how queries evolve over time and identify non-converting transitional queries, which can benefit from AI-driven enhancements.

Step 203B: Filtering Search Sequences Using Intent Analysis – To ensure query relevance, an intent filtering mechanism is applied to the identified search sequences. This process evaluates whether queries within a sequence share a common intent using a query similarity model. The alternate query generation engine compares each query with its predecessor in reverse order, ensuring that each step in the sequence maintains a logical connection to the user’s original search goal. If the similarity score between two consecutive queries falls below a predefined or predetermined threshold, the system drops the earlier queries as outside the intent boundary. This ensures that only relevant search refinements are considered when generating alternate queries.

Step 204B: Generating Alternative Queries Using LLM alternator – With the refined transitional queries, the alternate query generation engine invokes the LLM alternator to generate alternative query suggestions. The LLM, which has been fine-tuned on the item listing platform’s historical search patterns, takes the following input:

The source query

The list of transitional queries

The original converging queries

The model is guided by an instruction prompt that ensures it generates new, diverse converging queries while maintaining semantic relevance. Instead of simply repeating past queries, the LLM alternator incorporates world knowledge, including brand associations and common product attributes, to produce a more refined set of alternate search options. The result is a curated list of AI-generated alternative queries that enhance search discovery.

Step 205B: Integrating Alternate Queries into the Search Experience – Once the LLM alternator produces alternative queries, the alternate search experience engine processes the output and prepares it for real-time integration into item listing system search interface. When a user submits a transitional query, the alternate query generation engine:

Retrieves relevant product results for the query.

Fetches precomputed alternative queries from the item listing system’s database or generates new ones in real time.

Organizes the alternative queries into a carousel and integrates them into the Search Results Page (SRP).

Displays the enhanced search experience, allowing users to refine their search using AI-generated suggestions.

Step 206B: Evaluating Performance and Continuous Improvement – To ensure that the alternate query generation engine improves search effectiveness, the system tracks key performance metrics, including:

Click-through rate (CTR): Measures how often users engage with the alternate queries.

Conversion rate: Assesses whether alternate queries lead to purchases.

Session abandonment rate: Determines if the alternate queries help retain users.

A/B testing is conducted by comparing user sessions with and without AI-generated query carousels to measure their impact on search behavior. Additionally, user interactions with alternate queries are logged and used to fine-tune the LLM, ensuring continuous learning and adaptation to evolving search patterns.

This end-to-end implementation enhances the search experience by reducing friction, improving query relevance, and increasing the likelihood of successful product discovery. The modular architecture ensures scalability, allowing for further optimizations as user behavior, product inventory, and AI models evolve.

By way of example, a user begins a shopping session on item listing platform by entering the search term “gold necklace.” This initial search is classified as the source query, which marks the starting point of the user’s intent and serves as the anchor for modeling the search journey. As the session progresses, the user begins to refine their search, first typing “18k gold necklace,” then “18k gold diamond necklace,” and eventually “18k gold diamond necklace Brand Name.” These refinements are recognized by the system as transitional queries—intermediate search terms that show the user narrowing their focus but not yet completing a purchase. Together, these inputs form a query sequence, which is a structured list of queries made within the same session, capturing how the user’s intent evolves over time.

The system monitors this activity and detects a transactional event when the user clicks on a product and adds it to their cart—one of several predefined signals, referred to as bbowac events (Buy, Bid, Offer, Watch, Ask, Cart, Click), that indicate meaningful engagement. This final action marks the target query (“18k gold diamond necklace Brand Name”)—the query that led to a product interaction. Using this behavioral data, the system’s sequence generator and transition finder isolates the longest uninterrupted chain of queries (i.e., longest chain of queries) that leads to the transactional event. The longest chain of queries refers to the uninterrupted sequence of user-issued search queries that culminates in a transactional or goal-completion event (e.g., a purchase, form submission, or other meaningful interaction). This chain reflects a linear progression of user intent without deviation or session fragmentation. The system’s sequence generator is designed to extract this chain from raw behavioral logs, ensuring that each query is chronologically aligned and semantically coherent. Suppose a user issues the following queries over time: “buy running shoes,” “best trail shoes,” “Nike trail runners,” “shoe sizing chart,” and finally clicks “Add to Cart.” This uninterrupted series becomes the longest chain of queries. If an unrelated query like “how to cook rice” appeared between them, that break would terminate the chain before it.

To enhance reliability, the intent filtering module applies a query similarity model that removes outliers and verifies that all queries within the chain represent a consistent goal or information need. This model evaluates the semantic similarity between adjacent queries using embedding-based representations, and removes any queries that fall below a predefined similarity threshold, preserving only those that share the original intent.

Once the valid query sequence is identified, it is passed to the Large Language Model (LLM) alternate query generator, a model fine-tuned using instruction-based learning on thousands of similar user journeys. The model has been trained on sequences containing source, transitional, and target queries to learn how to generate alternate target queries—new search terms that are semantically aligned with the user’s original goal but are not exact duplicates of previously seen queries. In this case, the LLM outputs alternative queries such as “18k gold diamond necklace Tiffany & Co.,” “18k gold diamond pendant necklace,” and “18k white gold diamond necklace.” These new queries capture both the semantic direction of the original session and relevant brand-specific terms inferred from the original inputs.

When the same user or a similar user enters a transitional query like “18k gold diamond necklace” in the future, the system uses real-time inference to either retrieve cached results or invoke the LLM to generate alternate suggestions on demand. These alternate target queries are then surfaced on the Search Results Page (SRP) in a query carousel—a user interface component that displays clickable refined query options to help users explore more relevant results. This enhanced alternate search experience is powered by the search sciences module, which integrates with the search services interface to communicate with the UI in real time.

By combining user behavior data, intent filtering, semantic modeling, LLM-generated outputs, and UI delivery, the system reduces friction in search journeys, increases the likelihood of conversion, and improves the overall relevance of results. Each component—from query similarity thresholds to query ranking logic—works in coordination to guide the user toward a better shopping outcome. This example encapsulates how the technical solution dynamically understands user behavior and applies AI to enhance search navigation at every step.

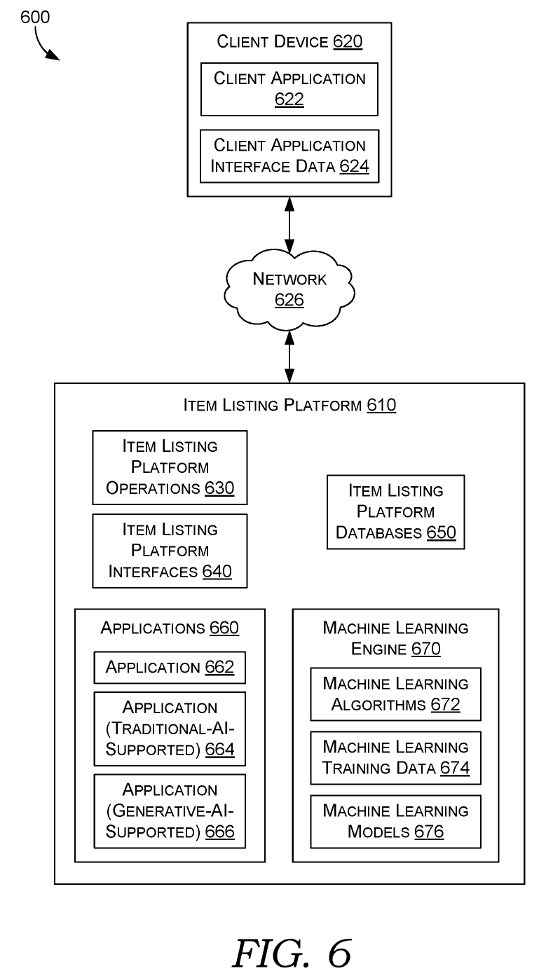

Aspects of the technical solution can be described by way of examples and with reference to FIGS. 1A – 1G and 2A – 2B. FIG. 2A is a block diagram of an exemplary technical solution environment, based on example environments described with reference to FIGS. 6, 7, and 8 for use in implementing embodiments of the technical solution are shown. Generally, the technical solution environment includes a technical solution system suitable for providing the example item listing system 600 in which methods of the present disclosure may be employed. In particular, FIG. 2A shows a high-level architecture of the cloud computing system 100 in accordance with implementations of the present disclosure. Among other engines, managers, generators, selectors, or components not shown (collectively referred to herein as “components”), the cloud computing system 100 of FIG. 2A support functionality described in FIGS. 1A – 1G.

### Example Methods

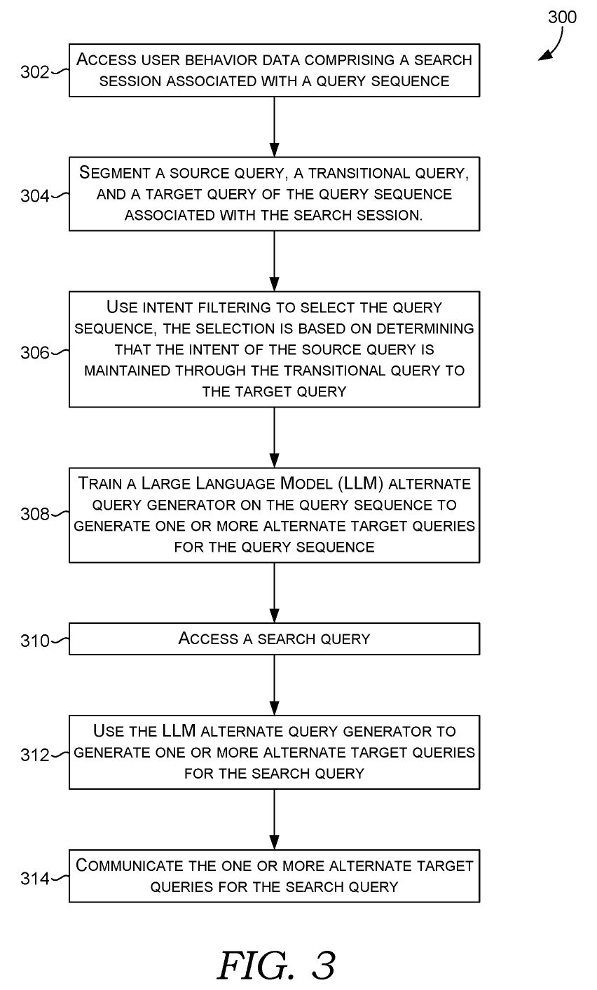

With reference to FIGS. 3, 4, and 5 flow diagrams that illustrate methods for providing alternate query generation in an artificial intelligence system. The methods may be performed using the artificial intelligence system described herein. In embodiments, one or more computer-storage media having computer-executable or computer-useable instructions embodied thereon that, when executed, by one or more processors can cause the one or more processors to perform the methods (e.g., computer-implemented method) in an artificial intelligence system (e.g., computerized system or computer system).

Turning to FIG. 3, a flow diagram is provided that illustrates a method 300 for providing alternate query generation in an artificial intelligence system. At block 302, access user behavior data comprising a search session associated with a query sequence. At block 304, segment a source query, a transitional query, and a target query of the query sequence associated with the search session. At block 306, using intent filtering, select the query sequence, wherein selecting the query sequence is based on determining that an intent of the source query is maintained from the source query through the transitional query to the target query. At block 308, train a Large Language Model (LLM) alternate query generator on the query sequence to generate one or more alternate target queries for the query sequence, wherein an alternate target query corresponds to an intent of the target query of the query sequence. At block 310, access a search query. At block 312, using the LLM alternate query generator, generate one or more alternate target queries for the search query. At block 314, communicate the one or more alternate target queries for the search query.

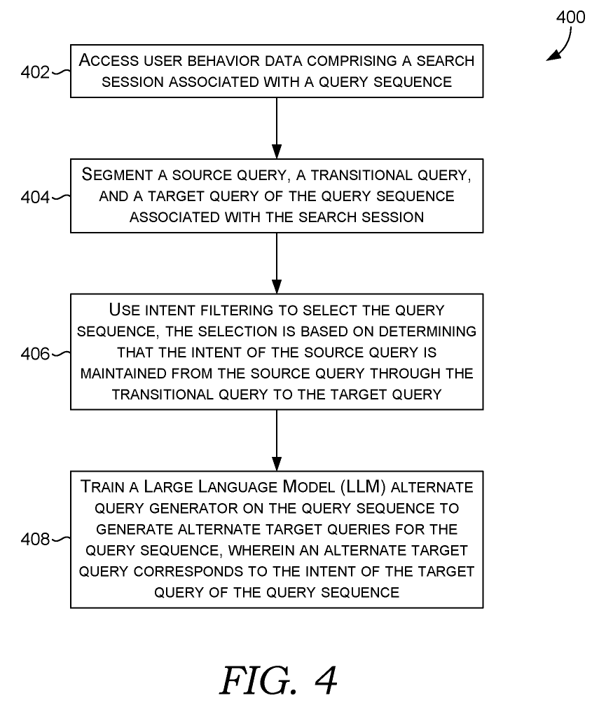

Turning to FIG. 4, a flow diagram is provided that illustrates a method 400 for providing alternate query generation in an artificial intelligence system. At block 402, access user behavior data comprising a search session associated with a query sequence. At block 404, segment a source query, a transitional query, and a target query of the query sequence associated with the search session. At block 406, using intent filtering, select the query sequence, wherein selecting the query sequence is based on determining that an intent of the source query is maintained from the source query through the transitional query to the target query. At block 408, train a Large Language Model (LLM) alternate query generator on the query sequence to generate one or more alternate target queries for the query sequence, wherein an alternate target query corresponds to an intent of the target query of the query sequence.

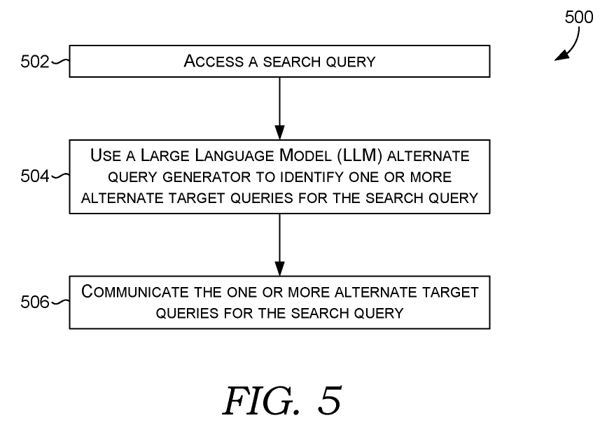

Turning to FIG. 5, a flow diagram is provided that illustrates a method 500 for providing alternate query generation in an artificial intelligence system. At block 502, access a search query. At block 504, using the LLM alternate query generator, generate one or more alternate target queries for the search query. The LLM alternate query generator is trained to generate an alternate target query based on a query sequence comprising a source query, a transitional query, and a target query, wherein an intent of the source query is maintained from the source query through the transitional query to the target query. At block 506, communicate the one or more alternate target queries for the search query.

### Technical Improvement

Embodiments of the present invention have been described with reference to several inventive features (e.g., operations, systems, engines, and components) associated with an item listing system. Inventive features described include operations, interfaces, data structures, and arrangements of computing resources associated with providing the functionality described herein relative with reference to a query management engine associated with an artificial intelligence system.

Embodiments of the present invention relate to the field of computing, and more particularly to an item listing system. The following described exemplary embodiments provide a system, method, and program product to, among other things, execute item listing system operations that provide a query management engine. Therefore, the present embodiments improve the technical field of artificial intelligence technology and item listing platform technology enhancing the efficiency and effectiveness of query management.

The alternate query generation engine operates based on a multi-stage transformation of raw user search behavior into structured alternate query experiences. Initially, the alternate query generation engine receives search sessions that include queries labeled with behavioral signals such as BBOWAC (behavioral-based outcome with actionable click), which denote high-engagement interactions. The sequence generator parses these sessions to extract query sequences with source, transition, and terminal queries, applying deduplication and segmentation logic based on conversion signals. The transition finder then aggregates similar chains and identifies intent-preserving transitions. The intent filter applies singularity embeddings to collapse semantically identical transitions, ensuring only meaningful variations are retained. Finally, the LLM alternator generates natural language alternate queries by combining pretrained word knowledge with user journey context. The output is surfaced via a search service pipeline that formats and delivers alternate query modules through the search front-end interface. This complete pipeline transforms raw behavioral signals into enhanced user-facing discovery experiences.

Advantageously, the query intelligence engine introduces several concrete technical improvements to item listing system technology. First, conversion-aware session pruning, by using BBOWAC-labeled events as anchor points, the system automatically filters out irrelevant or non-converting query chains, ensuring that only meaningful sequences contribute to the generation of alternate queries. This eliminates noise and enhances the precision of downstream models. Second, intent-specific transition compression, the use of singularity embeddings enables the system to recognize and collapse semantically redundant intent chains across large datasets. This significantly reduces the computational complexity and storage overhead involved in maintaining vast sets of user transitions while preserving semantic diversity. Third, contextualized alternate query generation, the integration of LLMs with user-specific search trajectories allows for the generation of context-rich alternate queries tailored to the user’s inferred intent. Unlike traditional query expansion models, this method preserves the structural coherence of the user journey and dynamically adapts output based on session context, improving user experience and discovery outcomes.

### Additional Support for Detailed Description of the Invention

### Example Item Listing System Environment

Referring now to FIG. 6, FIG. 6 illustrates an example item listing system 600 computing environment in which implementations of the present disclosure may be employed. In particular, FIG. 6 shows a high level architecture of an example item listing platform 610 that can host a technical solution environment, or a portion thereof. It should be understood that this and other arrangements described herein are set forth as examples. For example, as described above, many elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

The item listing system 600 can be a cloud computing environment that provides computing resources for functionality associated with the item listing platform 610. For example, the item listing system 600 supports delivery of computing components and services – including servers, storage, databases, networking, applications, and machine learning associated with the item listing platform 610 and client device 620. A plurality of client devices (e.g., client device 620) include hardware or software that access resources on the item listing system 600. Client device 620 can include an application (e.g., client application 622) and interface data (e.g., client application interface data 624) that support client-side functionality associated with the item listing system. The plurality of client devices can access computing components of the item listing system 600 via a network (e.g., network 626) to perform computing operations.

The item listing platform 610 is responsible for providing a computing environment or architecture that includes the infrastructure that supports providing item listing platform functionality (e.g., e-commerce functionality). The item listing platform support storing item in item databases and providing a search system for receiving queries and identifying search results based on the queries. The item listing platform may also provide a computing environment with features for managing, selling, buying, and recommending different types of items. Item listing platform 610 can specifically be for a content platform such as EBAY content platform or e-commerce platform, developed by EBAY INC., of San Jose, California.

The item listing platform 610 can provide item listing operations 630 and item listing interfaces 640. The item listing operations 630 can include service operations, communication operations, resource management operations, security operations, and fault tolerance operations that support specific tasks or functions in the item listing platform 610. The item listing interfaces 640 can include service interfaces, communication interfaces, resource interfaces, security interfaces, and management and monitoring interfaces that support functionality between the item listing platform components. The item listing operations 630 and item listing interfaces 640 can enable communication, coordination and seamless functioning of the item listing system 600.

By way of example, functionality associated with item listing platform 610 can include shopping operations (e.g., product search and browsing, product selection and shopping cart, checkout and payment, and order tracking); user account operations (e.g., user registration and authentication, and user profiles); seller and product management operations (e.g., seller registration and product listing and inventory management); payment and financial operations (e.g., payment processing, refunds and returns); order fulfillment operations (e.g., order processing and fulfillment and inventory management); customer support and communication interfaces (e.g., customer support chat/email and notifications); security and privacy interfaces (e.g., authentication and authorization, payment security); recommendation and personalization interfaces (e.g., product recommendations and customer reviews and ratings); analytics and report interfaces (e.g., sales and inventory reports, and user behavior analytics); and APIs and Integration Interfaces (e.g., APIs for Third-Party Integration).

The item listing platform 610 can provide item listing platform databases (e.g., item listing platform databases 650) to manage and store different types of data efficiently. The item listing platform databases 650 can include relational databases, NoSQL databases, search databases, cache databases, content management systems, analytics databases, payment gateway database, customer relationship management databases, log and error databases, inventory and supply chain databases, and multi-channel databases that are used in combination to efficiently manage data and provide e-commerce experience for users.

The item listing platform 610 supports applications (e.g., applications 660) that is a computer program or software component or service that serves a specific function or set of functions to fulfil a particular item listing platform requirement or user requirement. Applications can be client-side (user-facing) and server-side (backend). Applications can also include application without any AI support (e.g., application 662) application supported by traditional AI model (e.g., application 664), and applications supported by generative AI models (e.g., application 666). By way of example, applications can include an online storefront application, mobile shopping app, admin and management console, payment gateway integration, user account and authentication application, search and recommendation engines, inventory and stock management application, order processing and fulfillment application, customer support and communication tools, content management system, analytics and report applications, marketing and promotion applications, multi-channel integration applications, log and error tracking applications, customer relationship management (CRM) applications, security applications, and APIs and web services that are used in combination to efficiently deliver e-commerce experiences for users.

The items listing platform 610 can include a machine learning engine (e.g., machine learning engine 670). The machine learning engine 670 refers to machine learning framework or machine learning platform that provides the infrastructure and tools to design, train, evaluate, and deploy machine learning models. The machine learning engine 670 can serve as the backbone for developing and deploying machine learning applications and solutions. Machine learning engine 670 can also provide tools for visualizing data and model results, as well as interpreting model decisions to gain insights into how the model is making predictions.

The machine learning engine 670 can provide the necessary libraries, algorithms, and utilities to perform various tasks within the machine learning workflow. The machine learning workflow can include data processing, model selection, model training, model evaluation, hyperparameter tuning, scalability, model deployment, inference, integration, customization, data visualization. Machine learning engine 670 can include pre-trained models for various tasks, simplifying the development process. In this way, the machine learning engine 670 can streamline the entire machine learning process, from data preparation and model training to deployment and inference, making it accessible and efficient for different types of users (e.g., customers, data scientists, machine learning engineers, and developers) working on a wide range of machine learning applications.

Machine learning engine 670 can be implemented in the item listing system 600 as a component that leverages machine learning algorithms and techniques (e.g., machine learning algorithms 672) to enhance various aspects of the item listing query management engine’s functionality. Machine learning engine 670 can provide a selection of machine learning algorithms and techniques used to teach computers to learn from data and make predictions or decisions without being explicitly programmed. These techniques are widely used in various applications across different industries, and can include the following examples: supervised learning (e.g., linear regression: classification, support vector machines (SVM); unsupervised learning (e.g., clustering, principal component analysis (PCA), association rules (e.g., apriori); reinforcement learning (e.g., Q-Learning, deep Q-Network (DQN); and deep learning (e.g., neural networks, convolutional neural networks (CNN), and recurrent neural networks (RNN); and ensemble learning random forest.

Machine learning training data 674 supports the process of building, training, and fine-tuning machine learning models. Machine learning training data 674 consists of a labeled dataset that is used to teach a machine learning model to recognize patterns, make predictions, or perform specific tasks. Training data typically comprises two main components: input feature (X) and labels or target values (Y). Input features can include variables, attributes, or characteristics used as input to the machine learning model. Input features (X) can be numeric, categorical, or even textual, depending on the nature of the problem. For example, in a model for predicting house prices, input features might include the number of bedrooms, square footage, neighborhood, and so on. Labels or target values (Y) include the values that the model aims to predict or classify. Labels represent the desired output or the ground truth for each corresponding set of input features. For instance, in a spam email classifier, the labels would indicate whether each email is spam or not (i.e., binary classification). The training process involves presenting the model with the training data, and the model learns to make predictions or decisions by identifying patterns and relationships between the input features (X) and the target values (Y). A machine learning algorithm adjusts its internal parameters during training in order to minimize the difference between its predictions and the actual labels in the training data. Machine learning engine 670 can use historical and real-time data to train models and make predictions, continually improving performance and user experience.

Machine learning engine 670 can include machine learning models (e.g., machine learning models 676) generated using the machine learning engine workflow. Machine learning models 676 can include generative AI models and traditional AI models that can both be employed in the item listing system 600. Generative AI models are designed to generate new data, often in the form of text, images, or other media, based on patterns and knowledge learned from existing data. Generative AI models can be employed in various ways including content generation, product image generation, personalized product recommendations, natural language chatbots, and content summarization. Traditional AI models encompass a wide range of algorithms and techniques and can be employed in various ways including recommendation systems, predictive analytics, search algorithms, fraud detection, customer segmentation, image classification, Natural Language Processing (NLP) and A/B testing and optimization. In many cases, a combination of both generative and traditional AI models can be employed to provide a well-rounded and effective e-commerce experience, combining data-driven insights and creativity.

Machine learning engine 670 can be used to analyze data, make predictions, and automate processes to provide a more personalized and efficient shopping experience for users. By way of example, product recommendations search and filtering: pricing optimization, inventory and stock management: customer segmentation, churn prediction and retention, fraud detection, sentiment analysis, customer support and chatbots, image and video analysis, and ad targeting and marketing. The specific applications of machine learning within the item listing platform 610 can vary depending on the specific goals, available data, and resources.

### Example Distributed Computing System Environment

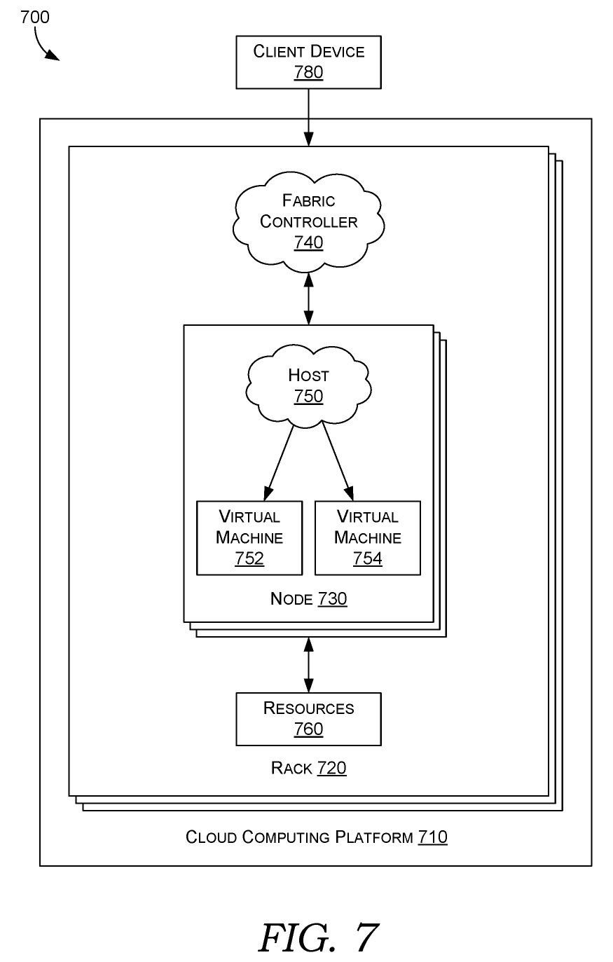

Referring now to FIG. 7, FIG. 7 illustrates an example distributed computing environment 700 in which implementations of the present disclosure may be employed. In particular, FIG. 7 shows a high-level architecture of an example cloud computing platform 710 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 700 that includes cloud computing platform 710, rack 720, and node 730 (e.g., computing devices, processing units, or blades) in rack 720. The technical solution environment can be implemented with cloud computing platform 710 that runs cloud services across different data centers and geographic regions. Cloud computing platform 710 can implement fabric controller 740 component for provisioning and managing resource allocation, deployment, upgrade, and management of cloud services. Typically, cloud computing platform 710 acts to store data or run service applications in a distributed manner. Cloud computing platform 710 in a data center can be configured to host and support operation of endpoints of a particular service application. Cloud computing platform 710 may be a public cloud, a private cloud, or a dedicated cloud.

Node 730 can be provisioned with host 750 (e.g., operating system or runtime environment) running a defined software stack on node 730. Node 730 can also be configured to perform specialized functionality (e.g., compute nodes or storage nodes) within cloud computing platform 710. Node 730 is allocated to run one or more portions of a service application of a tenant. A tenant can refer to a customer utilizing resources of cloud computing platform 710. Service application components of cloud computing platform 710 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 730, nodes 730 may be partitioned into virtual machines (e.g., virtual machine 752 and virtual machine 754). Physical machines can also concurrently run separate service applications. The virtual machines or physical machines can be configured as individualized computing environments that are supported by resources 760 (e.g., hardware resources and software resources) in cloud computing platform 710. It is contemplated that resources can be configured for specific service applications. Further, each service application may be divided into functional portions such that each functional portion is able to run on a separate virtual machine. In cloud computing platform 710, multiple servers may be used to run service applications and perform data storage operations in a cluster. In particular, the servers may perform data operations independently but exposed as a single device referred to as a cluster. Each server in the cluster can be implemented as a node.

Client device 780 may be linked to a service application in cloud computing platform 710. Client device 780 may be any type of computing device, which may correspond to computing device 800 described with reference to FIG. 7, for example, client device 780 can be configured to issue commands to cloud computing platform 710. In embodiments, client device 780 may communicate with service applications through a virtual Internet Protocol (IP) and load balancer or other means that direct communication requests to designated endpoints in cloud computing platform 710. The components of cloud computing platform 710 may communicate with each other over a network (not shown), which may include, without limitation, one or more local area networks (LANs) and/or wide area networks (WANs).

### Example Computing Environment

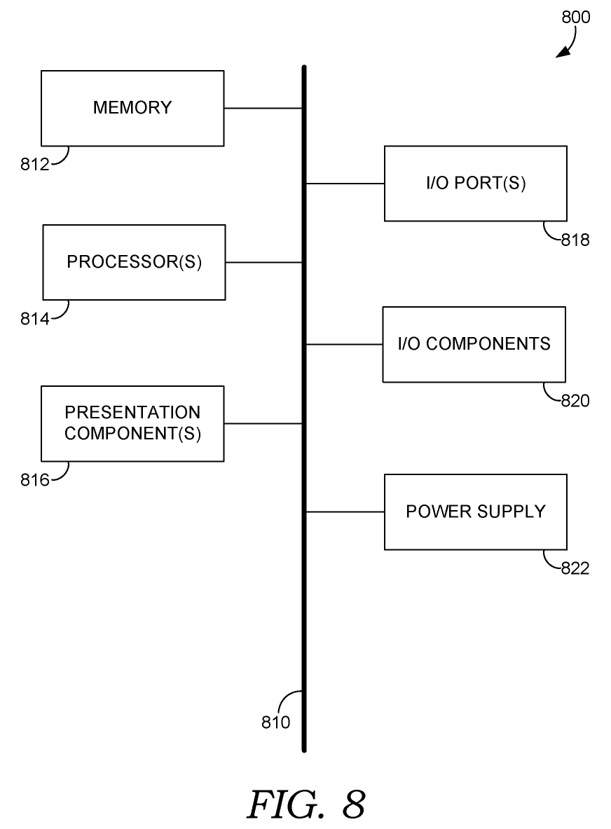

Having briefly described an overview of embodiments of the present invention, an example operating environment in which embodiments of the present invention may be implemented is described below in order to provide a general context for various aspects of the present invention. Referring initially to FIG. 8 in particular, an example operating environment for implementing embodiments of the present invention is shown and designated generally as computing device 800. Computing device 800 is but one example of a suitable computing environment and is not intended to suggest any limitation as to the scope of use or functionality of the invention. Neither should computing device 800 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output ports 818, input/output components 820, and illustrative power supply 822. Bus 810 represents what may be one or more buses (such as an address bus, data bus, or combination thereof). The various blocks of FIG. 8 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art and reiterate that the diagram of FIG. 8 is merely illustrative of an example computing device that can be used in connection with one or more embodiments of the present invention. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc.

### Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present invention may generally refer to the technical solution environment and the schematics described herein, it is understood that the techniques described may be extended to other implementation contexts.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious, and which are inherent to the structure.

It will be understood that certain features and sub-combinations are of utility and may be employed without reference to other features or sub-combinations. This is contemplated by and is within the scope of the claims.

What is claimed is:

1. A computer-implemented method, the method comprising:
accessing user behavior data comprising a search session associated with a query sequence;
segmenting a source query, a transitional query, and a target query of the query sequence associated with the search session;
using intent filtering, selecting the query sequence, wherein selecting the query sequence is based on determining that an intent of the source query is maintained from the source query through the transitional query to the target query;
training a Large Language Model (LLM) alternate query generator on the query sequence to generate one or more alternate target queries for the query sequence, wherein an alternate target query corresponds to an intent of the target query of the query sequence;
accessing a search query;
using the LLM alternate query generator, generating one or more alternate target queries for the search query; and
communicating the one or more alternate target queries for the search query.

2. The computer-implemented method of claim 1, wherein the query sequence is selected based on identifying a transactional event comprising a buy, bid, offer, watch, ask, cart or click event.

3. The computer-implemented method of claim 1, wherein segmenting the query sequence comprises identifying longest chain of queries leading up to a transactional event.

4. The computer-implemented method of claim 1, wherein intent filtering comprises traversing the query sequence in reverse and excluding a query when a similarity score to a previous query falls below a predetermined threshold.

5. The computer-implemented method of claim 1, wherein intent filtering uses a query similarity model to evaluate whether the intent of the source query is maintained, wherein a similarity score is computed using the query similarity model that measures embedding-based semantic similarity between adjacent queries.

6. The computer-implemented method of claim 1, wherein training the LLM alternate query generator comprises fine-tuning on a dataset of query sequences including source queries, transitional queries, and converging queries.

7. The computer-implemented method of claim 1, wherein generating the one or more alternate target queries comprises avoiding duplication of original converging queries of the query sequence.

8. The computer-implemented method of claim 1, the method further comprising presenting the one or more alternate target queries in a query carousel on a search results page.

9. The computer-implemented method of claim 1, wherein the one or more alternate target queries comprise brand-specific terms inferred from a user’s query sequence.

10. One or more computer-storage media having computer-executable instructions embodied thereon that, when executed by a computing system having a processor and memory, cause the processor to perform operations, the operations comprising:
accessing user behavior data comprising a search session associated with a query sequence;
segmenting a source query, a transitional query, and a target query of the query sequence associated with the search session;
using intent filtering, selecting the query sequence, wherein selecting the query sequence is based on determining that an intent of the source query is maintained from the source query through the transitional query to the target query; and
training a Large Language Model (LLM) alternate query generator on the query sequence to generate alternate target queries for the query sequence, wherein an alternate target query corresponds to an intent of the target query of the query sequence.

11. The media of claim 10, wherein segmenting the query sequence comprises identifying longest chain of queries leading up to a transactional event.

12. The media of claim 10, wherein intent filtering comprises traversing the query sequence in reverse and excluding a query when a similarity score to a previous query falls below a predetermined threshold.

13. The media of claim 10, wherein intent filtering uses a query similarity model to evaluate whether the intent of the source query is maintained, wherein a similarity score is computed using the query similarity model that measures embedding-based semantic similarity between adjacent queries.

14. The media of claim 10, wherein training the LLM alternate query generator comprises fine-tuning on a dataset of query sequences including source queries, transitional queries, and converging queries.

15. A computerized system comprising:
one or more computer processors; and
computer memory storing computer-useable instructions that, when used by the one or more computer processors, cause the one or more computer processors to perform operations, the operations comprising:
accessing a search query;
using a Large Language Model (LLM) alternate query generator, identifying one or more alternate target queries for the search query, wherein the LLM alternate query generator is trained to generate an alternate target query based on a query sequence comprising a source query, a transitional query, and a target query, wherein an intent of the source query is maintained from the source query through the transitional query to the target query; and
communicating the one or more alternate target queries for the search query.

16. The system of claim 15, the operations further comprising segmenting the source query, the transitional query, and the target query of the query sequence associated with a search session, wherein segmenting the query sequence comprises identifying longest chain of queries leading up to a transactional event.

17. The system of claim 15, wherein training the LLM alternate query generator comprises fine-tuning on a dataset of query sequences including source queries, transitional queries, and converging queries.

18. The system of claim 15, wherein generating the one or more alternate target queries comprises avoiding duplication of original converging queries of the query sequence.

19. The system of claim 15, the operations further comprising presenting the one or more alternate target queries in a query carousel on a search results page.

20. The system of claim 15, wherein the one or more alternate target queries comprise brand-specific terms inferred from a user’s query sequence.
